(19) United States
(12) Patent Application Publication
(10) Pub. No.: US 2005/0109286 A1
(43) Pub. Date: May 26, 2005

(54) Vibrating livestock prod with pneumatic actuation

(75) Inventors: Brian Lange, Green Bay, WI (US); Don Campbell, Green Bay, WI (US); Keith Gerarden, Oconto, WI (US)

Correspondence Address: WHYTE HIRSCHBOECK DUDEK S C, 555 EAST WELLS STREET, SUITE 1900, MILWAUKEE, WI, 53202, US

(73) Assignee: Packerland Packing Company, Inc.

(21) Appl. No.: 10/719,207

(22) Filed: Nov. 21, 2003

(51) Int. Cl. A01K 15/02

(52) U.S. Cl. 119/719

(57) ABSTRACT

The present invention provides a vibrating livestock prod with pneumatic actuation. The prod includes a pneumatically actuated vibratory stylus adapted for contacting a skin of an animal. A pneumatic system connects the prod to a pneumatic source, and a method contacts the animal with the vibratory stylus. The livestock prod is pneumatically actuated and vibrates against the skin of an animal to motivate and compel animal movement.

### CROSS-REFERENCES TO RELATED APPLICATIONS

### STATEMENT REGARDING FEDERALLY SPONSORED RESEARCH OR DEVELOPMENT

### REFERENCE TO MICROFICHE APPENDIX

### BACKGROUND OF THE INVENTION

1. Field of the Invention

The present invention relates to animal livestock prods, and more specifically, to a vibrating livestock prod with pneumatic actuation.

2. Description of Related Art

Animal livestock prods, including cattle prods, are both well-known and ubiquitous. They are useful for many purposes, including, for example, directing animal movement when loading and unloading them into and out of holding chutes, pens, restraining devices, conveyance devices, and the like. Thus, prodding presents a universally accepted humane technique for moving cattle and other animals on ranches, veterinary clinics, rodeos, slaughterhouses, and the like.

They are particularly useful after other attempts at moving an animal have failed. For example, they are routinely used and considered a more humane method than other options previously used in moving animals—such as, for example, kicking, securing a rope about the animal's head, whipping the animal with a rope or otherwise, hitting or paddling the animal with a board or otherwise, or twisting the animal's tail. These other methods are known to bruise the animal, and can severely injure them, with a net effect of getting far less movement than with a gentle tap from a prod. Thus, those involved in live animal management—including ranchers, farmers, meat packers, slaughterhouse personnel, animal trainers, veterinarians, and humane societies, etc.—have long used animal livestock prods to humanely corral and move animals.

Current animal livestock prods generally fall into one of several categories, including the following: i) stock prod devices, which feature a sharpened tip or point to motivate and compel animal movement, and ii) electric prod devices, occasionally referred to as “hot shots,” which urge electrical contact between spaced apart electrodes that are brought into direct and physical contact with an animal. A non-exhaustive list of such devices include the following:

| U.S. Pat. No. | Patentee | Issue Date |
|---|---|---|
| Des. 244,626 | Andrews | Jun. 07, 1977 |
| Des. 250,050 | Bros | Oct. 24, 1978 |
| Des. 257,495 | Bros et al. | Nov. 04, 1980 |
| Des. 289,313 | Shy | Apr. 14, 1987 |
| Des. 318,149 | Young | Jul. 09, 1991 |
| Des. 468,066 | Helms et al. | Dec. 31, 2002 |
| 1,193,168 | Martin | Aug. 01, 1916 |
| 2,176,994 | Hansen et al. | Oct. 24, 1939 |
| 2,484,147 | Bartel | Oct. 11, 1949 |
| 2,733,003 | Abildgaard et al. | Jan. 31, 1956 |
| 3,575,340 | Klebold | Apr. 20, 1971 |
| 3,998,459 | Henderson et al. | Dec. 21, 1976 |
| 4,084,218 | Kenney | Apr. 11, 1978 |
| 4,167,036 | Kenney | Sep. 04, 1979 |
| 4,367,843 | Bros et al. | Jan. 11, 1983 |
| 4,394,956 | Andrews et al. | Jul. 26, 1983 |
| 4,424,932 | Allen | Jan. 10, 1984 |
| 6,460,489 | O'Byrne | Oct. 08, 2002 |

Another possible category of animal livestock prods includes vibrating prod devices, which feature a vibrating head in electrical and mechanical arrangement and communication with a motor to transfer vibrations to a distal end thereof. A non-exhaustive list of such devices include U.S. Pat. No. 6,460,489 to O'Byrne, issued on Oct. 8, 2002.

In some respects, electrical prod devices can be considered more effective than stock prod devices. For example, they do not require prodding the animal with great force, and thus, the animal's flesh is not readily or easily bruised. Nevertheless, when many animals experience unexpected electrical shocks, they often respond by panicking, and then often become more and more aggressive as they become more and more confined. Furthermore, when an alarmed animal panics, it may then inadvertently cause itself further contact with the electrical prod device, and the electrical prod's projecting plural electrode tips can then further penetrate the animal's skin. Moreover, when preparing meat animals for slaughter, many sense danger, and consequently, become distressed and disquiet. The sudden electrical shock can then further result in emotional trauma experienced by the animal, characterized by frazzled animal nerves, a sudden adrenaline rush, and extreme muscle contractions leading to bruising or other injury. Accordingly, both the physical puncture wounds and emotional trauma can adversely effect meat color and quality when electrical prod devices are used to prepare slaughter animals for human consumption.

To the extent electrical prod devices can be considered more effective than stock prod devices in some respects, vibrating stock prod devices can also be considered even more effective than electrical prod devices. They avoid needless suffering, and in the context of meat animals for slaughter, avoid the afore-mentioned deteriorating meat color and quality. The aforementioned vibrating prod device, however, suffers from numerous drawbacks, including a notable lack of power—and therefore notable lack of effectiveness—due to its limited battery-powered operation.

Moreover, such a device—like all the electrical prodding devices—relies upon numerous electrical connections. A serious problem associated with all devices that rely on electrical connections is preventing electrical malfunctions, such as short circuits, that are often caused by the entry of moisture (rain, snow, etc.), dust, dirt, and other foreign substances and contaminants into the device. This problem is particularly exacerbated when the device is used in a particularly dirty environment, such as a ranch, slaughterhouse, or the like, as is common.

Thus, what remains needed in the industry is a reliable, humane, powerful, and effective animal livestock prod, including apparatus, systems, and methods related thereto.

### SUMMARY OF THE INVENTION

The present invention provides a vibrating livestock prod with pneumatic actuation. It provides a reliable, humane, powerful, and effective animal livestock prod that substantially eliminates, or at least substantially reduces, both physical puncture wounds and emotional trauma to prodded animals. It provides effective apparatus, systems, and methods related to prodding animal mobility, including meat animals for slaughter in a slaughterhouse. Consistent with increased animal welfare issues and ethical treatment, it provides a pneumatically actuated vibrating livestock prod device to replace or supplement stock prod devices and electrical stock prod devices.

Efficient operation of most commercial meat packing plants requires that cattle, for example, be passed through various handling equipment in a steady, continuous fashion at a desired speed without interruption to regular advancement through the various stages of processing. Accordingly, it is an object of the present invention to provide effective apparatus, systems, and methods related to pneumatically prodding animal mobility. The inventive arrangements improve animal prodding efficiency. They provide a reliable prodding device and system that do not require electrical components and avoids many of the common problems associated with prodding devices that rely upon numerous electrical connections. They provide a livestock handling device that can effectively and ethically move livestock using pneumatically generated external vibratory stimulus without injuring the animals. They are humane, cost-effective, and easy to make, use, repair, and maintain. They reduce painful, stressful, and costly animal bruising, carcass damage, and premature stress-related animal deaths.

More specifically, the present invention provides a vibrating livestock prod with pneumatic actuation, comprising a pneumatic scribe having a vibratory stylus adapted for contacting a skin of an animal, a pneumatic trigger, and an elongated shaft connecting the trigger to the scribe. In another embodiment, the present invention provides a system for motivating animal movement, comprising: a) a vibrating livestock prod with pneumatic actuation, the prod comprising: i) a pneumatic scribe having a vibratory stylus adapted for contacting a skin of an animal; ii) a pneumatic trigger; and iii) an elongated shaft connecting the trigger to the scribe; and b) a pneumatic source connected to the prod. In yet another embodiment, the present invention provides a method for motivating animal movement, comprising: a) providing a vibrating livestock prod having a vibratory stylus adapted for contacting a skin of an animal; b) vibrating the stylus with gas from a pneumatic source; and c) contacting the animal with the stylus.

### THE DRAWINGS

A clear conception of the advantages and features constituting inventive arrangements, and of various construction and operational aspects of typical mechanisms provided therewith, will become readily apparent by referring to the following exemplary, representative, and non-limiting illustrations, which form an integral part of this Specification, wherein like reference numerals generally designate the same elements in the several views, and in which:

FIG. 1 is a plan view of a pneumatic system comprising a vibrating livestock prod with pneumatic actuation and a pneumatic source;

FIG. 2 is an alternative plan view of a pneumatic system in which a pneumatic source is one of many components of an overall larger pneumatic supply system, as commonplace in a slaughterhouse for example;

FIG. 3 is an alternative plan view of a pneumatic system in which a pneumatic source is transportable;

FIG. 4 is a detailed cross-sectional view of the pneumatic scribe taken along line 4-4 of FIG. 1; and

FIG. 5 is a detailed cross-sectional view of the pneumatic trigger taken along line 5-5 of FIG. 1.

### DETAILED DESCRIPTION

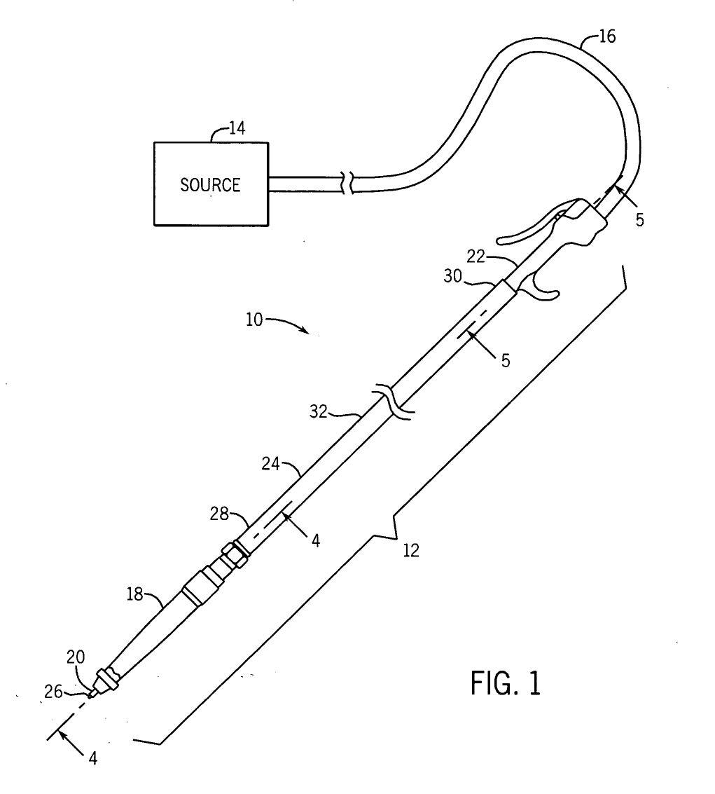

Referring now to FIG. 1, a pneumatic system 10 for motivating and compelling animal movement is shown, in which a vibrating livestock prod 12 is shown connected to a pneumatic source 14 through a pneumatic hose 16. Preferably, the pneumatic hose 16 is made of one or more flexible construction materials, as known in the art, and is suitably dimensioned to permit the vibrating livestock prod 12 and the pneumatic source 14 to be located remotely relative to one another.

In a preferred embodiment, the vibrating livestock prod 12 is pneumatically actuated and comprises a pneumatic scribe 18 having a vibratory stylus 20 adapted for contacting a skin of an animal (not shown), a pneumatic trigger 22, and an elongated shaft 24 connecting and extending between the pneumatic trigger 22 and the pneumatic scribe 18, preferably with sealing threaded type connection end-pieces.

More specifically, an exemplary, representative, and non-limiting pneumatic scribe 18 is a Pneumatic Air Scribe available from Chicago Pneumatic Tool Company of Chicago, Ill., part number CP-9361 Air Scribe Model “A.” As such, a tip 26 of the vibratory stylus 20 of the pneumatic scribe 18 is preferably manually, mechanically, or machine ground with a file, chisel, bench grinder, grinding wheel, or the like—or otherwise appropriately adapted to form a generally blunt surface—to make contact with the skin of the animal, preferably without piercing or otherwise causing injury thereto. More specifically, many livestock animals are larger than humans and have hides that are many times thicker than human skin. A human person's skin is approximately 1-2 mm thick, whereas horsehide is about 5 mm thick, bullhide is about 7 mm thick, and cattlehide is about 5-6 mm thick. Whereas human skin could bruise or suffer injury from application of or contact with the pneumatic scribe 18, the animals' thicker hides offer increased resistance to cutting or bruising by the vibratory stylus 20. Thus, the tip 26 of the pneumatic scribe 18 is designed to maximize its effect on the animal without causing cutting, piercing, bruising, or other injury, generally causing discomfort, but no pain in operation.

An exemplary, representative, and non-limiting pneumatic trigger 22 is a 600 Series Blow Gun available from Coilhouse Pneumatics of both East Brunswick, N.J. and McMinnville, Oreg., part number 600S-DL Safety (standard). As such, the pneumatic trigger 22 is preferably selectively actable to permit pressurized or compressed gas to flow between the pneumatic trigger 22 and the pneumatic scribe 18, and more specifically, to flow from the pneumatic trigger 22 to the pneumatic scribe 18 in order to vibrate the vibratory stylus 20 against the skin of the animal. Similarly, the pneumatic trigger 22 is also preferably selectively actable to provide a pneumatic passageway for pressurized or compressed gas to flow between the pneumatic trigger 22 and the pneumatic scribe 18, and more specifically, to flow from the pneumatic trigger 22 to the pneumatic scribe 18 in order to vibrate the vibratory stylus 20 against the skin of the animal. Thus, the pneumatic trigger 22 is functionally and suitably connected to and between the pneumatic source 14 (or the pneumatic hose 16) and the elongated shaft 24 of the vibrating livestock prod 12 for delivery of a pressurized or compressed gas from the former to the latter. Accordingly, the pneumatic trigger 22 is preferably in pneumatic communication with both the pneumatic source 14 and the elongated shaft 24, being generally intermediate and responsive thereto.

In other preferred embodiments, the elongated shaft 24 contains, provides, or otherwise supports the aforementioned pneumatic passageway between and from the pneumatic trigger 22 to the pneumatic scribe 18. Accordingly, the elongated shaft 24 is preferably either hollow or substantially hollow, having none or few obstructions (including, for example, electrical wires and other electrical components and the like) for blocking pneumatic flow between and from the pneumatic trigger 22 to the pneumatic scribe 18. As such, the elongated shaft 24 preferably permits pressurized or compressed gas to flow between the pneumatic trigger 22 and the pneumatic scribe 18 with minimum flow interruption therebetween.

Suitable length dimensions for the elongated shaft 24 will be understood by those skilled in the art of live animal handling and the like, and can be, by way of exemplary, representative, and non-limiting example, approximately 1′, 2′, 3′, 4′, 5′, 6′, 7′, or 8′, or of any other whole or incremental variations thereof. A telescoping elongated shaft 24 capable of varying lengths, depending on a particular animal application, is also contemplated. A suitable diameter of the elongated shaft 24 for particular use with the aforementioned pneumatic scribe 18 and pneumatic trigger 22 has been found to be approximately ⅜ inch diameter, and the elongated shaft 24 is preferably threaded on both of its distal ends for easy connection to and between the pneumatic trigger 22 and the pneumatic scribe 18. Accordingly, in the preferred embodiment, the pneumatic scribe 18 is preferably proximate a first distal end 28 of the elongated shaft 24 while the pneumatic trigger 22 is preferably proximate a second distal end 30 of the elongated shaft 24, the first distal end 28 and second distal end 30 being relatively referenced from an approximate midpoint 32 of the elongated shaft 24. Preferably, the elongated shaft 24 is generally rigid and not subject to deflection or deformation.

In other preferred embodiments, other means are also contemplated for connecting the pneumatic trigger 22 with and to the pneumatic scribe 18. For example, connecting means other than an elongated shaft 24 are also within the contemplation of the inventive arrangements, such as, for example, a flexible or inflexible hose running alongside, or otherwise supported by, the elongated shaft 24. In other preferred embodiments, for example, the pneumatic trigger 22 is otherwise in suitable pneumatic communication with the pneumatic scribe 18, whereby the elongated shaft 24 is functionally unnecessary or eliminated. In yet other preferred embodiments, pneumatic means are provided for vibrating the vibratory stylus 20 against the skin of the animal in order to motivate and compel animal movement. In still other preferred embodiments, the vibrating livestock prod 12 comprises the pneumatic scribe 18 adapted for contacting the skin of the animal. In yet other preferred embodiments, the vibrating livestock prod 12 comprises pneumatic means for vibrating the pneumatic stylus 20 against the skin of the animal.

The pneumatic system 10 preferably utilizes the pneumatic source 14 to provide the primary motive force to vibrate the vibratory stylus 20 of the pneumatic scribe 18, and more specifically, to vibrate the tip 26 of the vibratory stylus 20 against the skin of the animal. Accordingly, each of the vibrating livestock prod 12, the pneumatic scribe 18, and the vibratory stylus 20, including its tip 26, can all be said to be, and are, pneumatically actuated. As such, the pneumatic source 14 preferably provides a pneumatic gas (not shown) as part of, and to, the various components of the pneumatic system 10. Exemplary, representative, and non-limiting pneumatic gases include, for example, air, CO₂, and others.

Preferably, the pneumatic gas is pressurized or compressed by the pneumatic source 14. As readily understood by those skilled in the art, various amenities or features (not shown) can be readily adapted and used in conjunction with the pneumatic source 14, such as, by way of exemplary, representative, and non-limiting example, the following: i) a filter and moisture separator (i.e., particularly beneficial and useful if excessive dirt or moisture is, or is believed to be, present in the pneumatic system 10); ii) a pressure regulator (i.e., particularly beneficial and useful to maintain a constant or near-constant pneumatic supply pressure if the pneumatic supply pressure from the pneumatic source 14 is, or is believed to be, of relatively widely varying magnitudes; iii) a pneumatic lubricator (i.e., particularly beneficial and useful if the pneumatic source 14 or vibrating livestock prod 10 are, or are believed to be, used in continuous or near-continuous operation); iv) one or more master control switches, such as shut-off or emergency control valves and the like; v) a pneumatic filter, such as, for example, an air filter, used in conjunction with, or otherwise made a part of, the pneumatic source 14, the pneumatic scribe 18, or other; and vi) a pneumatic compressor, such as, for example, an air compressor. Regardless, the pneumatic source 14 provides the compressed or pressurized gas to the vibrating livestock prod 12 in order to vibrate the vibratory stylus 20 against the skin of the animal.

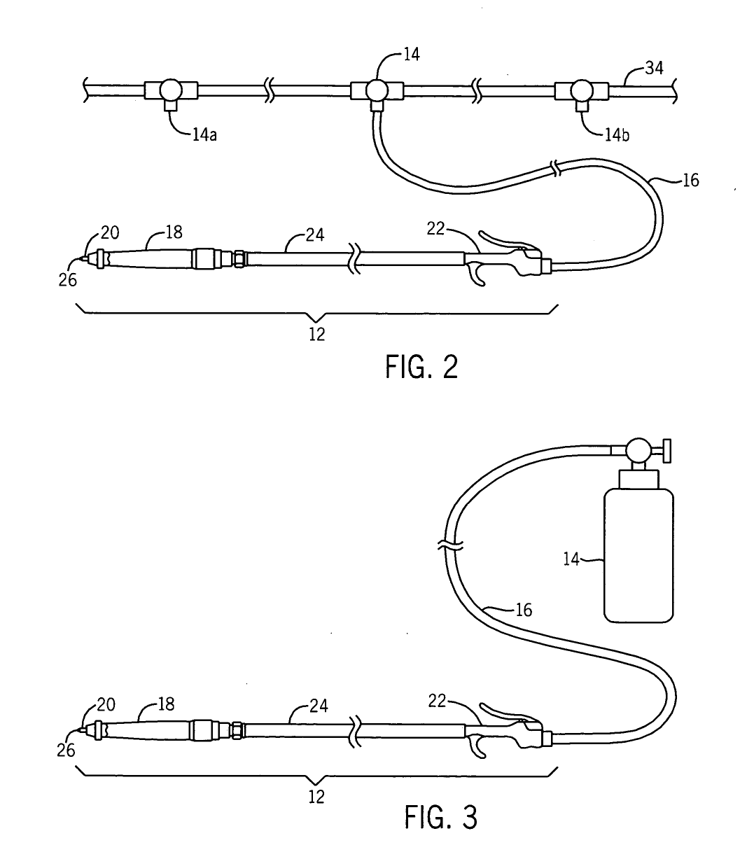

Referring now to FIG. 2, a preferred pneumatic source 14, as previously mentioned, comprises a pneumatic compressor such as, for example, an air compressor. Since pneumatic compressors, such as, for example, air compressors, are commonplace in slaughterhouses and the like, preferred pneumatic sources 14 comprise the pneumatic compressor commonly found, or readily installed, in animal slaughterhouses. Accordingly, the pneumatic source 14 can be one of many components of an overall larger pneumatic supply system 34 as commonplace in slaughterhouses and like. As an animal handler, for example, thus moves about a slaughterhouse, various pneumatic source inputs 14a, 14b can be provided as entrance nodes for the described and illustrated pneumatic system 10. As known, such pneumatic sources 14 are commonplace in slaughterhouses and the like for a variety of functions, including, for example, providing supply gas or air for foam solutions for cleaning bulkheads and floors, providing air knives for dehiding cattle, cattle leg spreading, etc.

Alternatively, and referring now to FIG. 3, another preferred pneumatic source 14 is transportable, preferably comprising one or more wheels (not shown) for transport. Alternative methods of transport are also contemplated, but not shown, by the inventive arrangements, including, for example, transporting the pneumatic source 14 by foot, bag, saddle bag, back pack, pack saddle, car or truck or boat, and the like.

In preferred operation of both the vibrating livestock prod 12 and the system 10 embodying the same, the vibratory stylus 20 of the pneumatic scribe 18 is set in motion by the pressurized or compressed gas from the pneumatic source 14 in conjunction with selective actuation of the pneumatic trigger 22 by a preferably human operator (not shown), who then brings the vibrating livestock prod 12 into direct and physical contact with the external outer skin or hide of the animal to be moved. Alternatively, the vibratory stylus 20 can also be set in motion after the vibrating livestock prod 12 is brought into the direct and physical contact with the outer skin of the animal, or via on-off pulsing of the vibratory stylus 20 with selective and periodic actuation of the pneumatic trigger 22, as desired or required, for example, to humanely motivate and compel animal mobility. In any event, the vibratory stylus 20 is generally brought into contact with the animal in the hip and shoulder areas thereof (where nerve endings generally tend to be less dense and the sensations tend to be weaker) for one or more seconds per application. This is generally considered a humane way to move animals, including, for example, moving animals into animal restraining devices in slaughterhouses and the like.

Accordingly, various exemplary, representative, and non-limiting methodological embodiments of the inventive arrangements include at least the following: i) providing the vibrating livestock prod 12, vibrating the vibratory stylus 20 with pressurized or compressed gas from the pneumatic source 14, and contacting the skin of the animal with the vibratory stylus 20; ii) providing the vibrating livestock prod 12, providing the pneumatic source 14 connected to and in pneumatic communication therewith, vibrating the vibratory stylus 20 with pressurized or compressed gas from the pneumatic source 14, and contacting the skin of the animal with the vibratory stylus 20; iii) providing the vibrating livestock prod 12, providing the pneumatic source 14 connected to and in pneumatic communication therewith through the pneumatic hose 16, vibrating the vibratory stylus 20 with pressurized or compressed gas from the pneumatic source 14, and contacting the skin of the animal with the vibratory stylus 20; and iv) pneumatically vibrating the vibratory stylus 20 against the skin of the animal. As such, the vibrating livestock prod 12 relies primarily on vibrations and vibratory forces in order to motivate and compel desired or required animal movement.

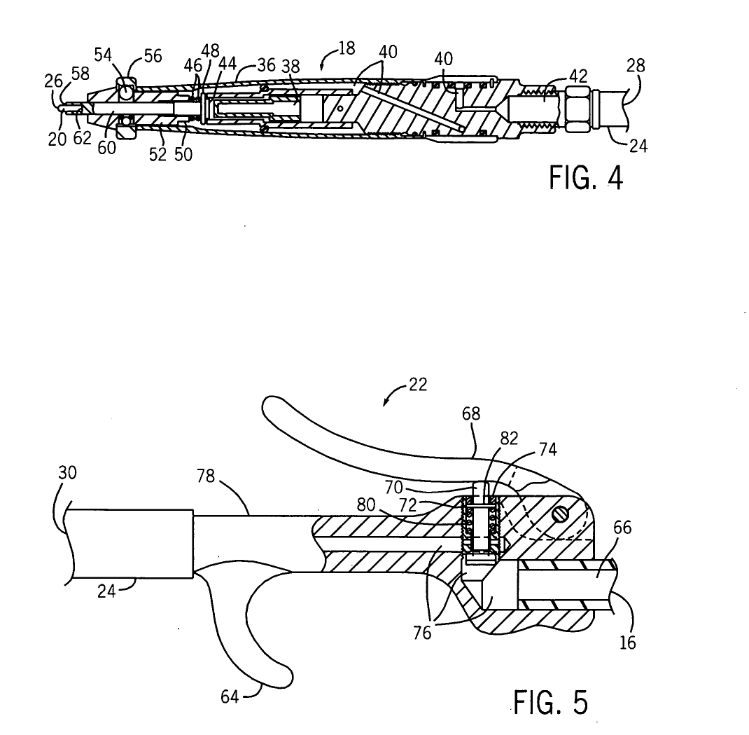

Referring now to FIG. 4, a detailed cross-sectional view of the pneumatic scribe 18 of the vibrating livestock prod 12 of the pneumatic system 10 of FIG. 1 is shown, taken along line 4-4 thereof. More specifically, an outer shell housing 36 receives an internal sliding piston 38 therewithin, the sliding piston 38 being operable on by the pressurized or compressed gas received at and from the first distal end 28 of the elongated shaft 24. This sliding piston 38 is preferably propelled into lateral reciprocating motion by the pressurized or compressed gas through various passageways 40 connecting and extending from a central scribe inlet 42 that is, either directly or indirectly, in pneumatic communication with the pneumatic source 14.

This sliding piston 38 also has various passageways therein (not shown), which are either opened or closed according to their relative positions, and which thereby cause the sliding piston 38 to rapidly reciprocate and repeatedly strike an anvil portion 44 of the pneumatic scribe 18. More specifically, as the propelling gas is directed to and through the various passageways 40, the sliding piston 38 is impelled first in one direction, and then in the other, within the outer shell housing 36 by the pressurized or compressed gas from the pneumatic source 14. The various passageways in the sliding piston 38, in turn, alternatively direct the incoming gas to impel the sliding piston 38 to repeatedly and alternatively strike and then withdraw from the anvil portion 44 of the stylus assembly. For satisfactory performance, approximately 90 psig of pressurized or compressed gas from the pneumatic source 14 is generally sufficient to impart typical vibratory forces to vibrate the vibratory stylus 20, although a range of 80-130 psig can also be used to provide satisfactory performance depending, in part, on other design parameters. Preferably, the vibratory stylus 20 vibrates at a rate sufficient to motivate and compel animal movement.

A plurality of o-rings 46 are also utilized between a flange 48 of the stylus assembly and a shoulder 50 of a stylus holding bushing 52 formed proximate a distal end of the outer shell housing 36. These o-rings 46 are physically compressed when the stylus assembly is struck by the sliding piston 38, and then act as a spring to return or bias the stylus assembly back towards the withdrawn sliding piston position. Thus, the O-rings 46 help both reduce and channel vibrations of the outer shell housing 36, and urge the stylus assembly back towards its starting or non-engaged positioning.

As known in the art, the stylus holding bushing 52 may also comprise either a pair of ball bearings 54 (⅛ and 5/32 inch preferred diameters) held in place by a sleeve 56 that is rotated to position at least one of the ball bearings 54 into contact with a rotation restraining flat area provided upon a version of the vibratory stylus 18 having a chisel-like end or the like, or, alternatively, not be outfitted as such, and designed accordingly.

In a preferred embodiment, the tip 26 of the vibratory stylus 20 is preferably made from a material such as tungsten carbide, press-fit into a bore 58 at a distal end of a reciprocating stem 60, and forcibly and repeatedly hammered against a bottom 62 of the bore 58. Lengths of approximately ½ to 3 inches are generally preferred for the tip 26, depending on anticipated animal usage, and both readily replaceable and interchangeable tips 26 are suitably beneficial. Since a vibratory force (as opposed to an electrical force) is imparted to the tip 26, a singular tip 26 (as opposed to plural tips) is preferred. In other words, the need for plural tips is diminished.

The vibratory stylus 20 moves rapidly back and forth in accordance with the motion of the sliding piston 38 relative to the anvil portion 44 of the pneumatic scribe 18 and the reciprocating stem 60. Accordingly, sound and sound waves are generated by the work-pieces (i.e., by the moving mechanical parts). This has proven to be beneficial for further motivating and compelling the animal movement. More specifically, it was previous noted that the vibrating livestock prod 12 relies principally on vibrations and vibratory forces in order to motivate and compel animal mobility. However, the sound of the operating pneumatic scribe 18, which is most accurately characterized as reminiscent of a dentist's drill or teeth cleaning equipment, has also proven effective for these same purposes. For example, prior to contacting the animal, the human operator can first “buzz” the vibrating livestock prod 12 by briefly engaging the pneumatic trigger 22 one or more times without actually contacting the skin or hide of the animal with the pneumatic scribe 22 to see if the animal responds thereto.

It is to be understood, however, that the inventive arrangements may be practiced in other specific pneumatic scribe forms and formats which are not described hereinout, yet that do not depart from the spirit and essential characteristics hereof. Thus, the described pneumatic scribe 18 was only intended to be an exemplary, representative, and non-limiting description of such a suitable scribing device, and all changes that come within the meaning and range of equivalency are intended to be embraced hereby.

Referring now to FIG. 5, a detailed cross-sectional view of the pneumatic trigger 22 of the vibrating livestock prod 12 of the pneumatic system 10 of FIG. 1 is shown, taken along line 5-5 thereof. More specifically, a stationary hand-grip stabilizer 64, such as a pistol grip, depends downwardly and is preferably provided for exerting physical control over the vibrating livestock prod 12, the hand-grip stabilizer 64 being generally proximal to the second distal end 30 of the elongated shaft 24. A second end of the pneumatic trigger 22 is then proximate the pneumatic hose 16 for receiving the pressurized or compressed gas from the pneumatic source 14, preferably through a central trigger inlet 66 that receives the abrupt inrush of gas upon the selective actuation of the pneumatic trigger 22. Accordingly, the central trigger inlet 66 preferably has a large cross-sectional area.

A preferably pivotal operating lever 68 operates in conjunction with a moveable plunger 70 disposed in a sleeve 72 containing one or more o-rings 74 permitting the pressurized or compressed gas to pass from the pneumatic source 14 to the elongated shaft 24 through one or more various passageways 76 that are internally disposed within the pneumatic trigger 22. When the operating lever 68 is depressed towards the body 78 of the pneumatic trigger 22, or otherwise engaged, the pressurized or compressed gas from the pneumatic source 14 is permitted to flow through the pneumatic trigger 22, and when it is released or otherwise disengaged, it is biased by one or more springs 80, which are preferably separated from the one or more o-rings 74 by a barrier 82, towards a withdrawn position to prevent such pneumatic flow at its starting or non-engaged positioning. As understood by those skilled in the art, the plunger 70 thus acts to either permit or prohibit pneumatic flow through the pneumatic trigger 22 to actuate the pneumatic scribe 18. In any event, a preferred ergonomic implementation of the pneumatic trigger 22 can be effective at reducing user discomfort and fatigue, even during extended periods of volume operation of the vibrating livestock prod 12.

It is to be understood, however, that the inventive arrangements may be practiced in other specific pneumatic trigger forms and formats which are not described hereinout, yet that do not depart from the spirit and essential characteristics hereof. Thus, the described pneumatic trigger 22 was only intended to be an exemplary, representative, and non-limiting description of such a suitable triggering device, and all changes that come within the meaning and range of equivalency are intended to be embraced hereby.

Moreover, whereas the vibrating livestock prod 12 has been generally illustrated and described as comprising three or more separate and distinct components—including, for example, the air scribe 18, the pneumatic trigger 22, and the elongated shaft 24—combining any or all thereof into integral or integrated components is also hereby contemplated. They were functionally illustrated and described separately to conceptually aid and enhance readability and understanding.

It should be understood that this Specification describes exemplary, representative, and non-limiting embodiments of the inventive arrangements. Accordingly, the scope of this invention is not limited to any of these embodiments. Rather, the details and features of these embodiments were disclosed as required. Thus, many changes and modifications—as apparent to those skilled in the art—are within the scope of the invention without departing from the scope hereof, and the inventive arrangements are necessarily inclusive thereof. Accordingly, to apprise the public of the spirit and scope of this invention, the following claims are made:

1. A vibrating livestock prod with pneumatic actuation, comprising:
a pneumatic scribe having a vibratory stylus adapted for contacting a skin of an animal;
a pneumatic trigger; and
an elongated shaft connecting said trigger to said scribe.

2. The vibrating livestock prod of claim 1 wherein said scribe is proximate a first distal end of said shaft and said trigger is proximate a second distal end of said shaft.

3. The vibrating livestock prod of claim 1 wherein said stylus is pneumatically actuated.

4. The vibrating livestock prod of claim 1 wherein said shaft is substantially hollow.

5. The vibrating livestock prod of claim 1 wherein said shaft contains a pneumatic passageway.

6. The vibrating livestock prod of claim 1 wherein said shaft provides a pneumatic passageway.

7. The vibrating livestock prod of claim 1 wherein said shaft supports a pneumatic passageway.

8. The vibrating livestock prod of claim 1 wherein said shaft permits pressurized or compressed gas to flow.

9. The vibrating livestock prod of claim 1 wherein said shaft permits pressurized or compressed gas to flow between said trigger and said scribe.

10. The vibrating livestock prod of claim 1 wherein said shaft permits pressurized or compressed gas to flow from said trigger to said scribe.

11. The vibrating livestock prod of claim 1 wherein said shaft permits pressurized or compressed gas to flow from said trigger to said scribe in order to vibrate said stylus.

12. The vibrating livestock prod of claim 1 wherein said shaft permits pressurized or compressed gas to flow from said trigger to said scribe in order to vibrate said stylus against the skin of said animal.

13. The vibrating livestock prod of claim 12 wherein said gas is air or CO₂.

14. The vibrating livestock prod of claim 1 wherein said trigger is selectively actable.

15. The vibrating livestock prod of claim 1 wherein said trigger is selectively actable to permit pressurized or compressed gas to flow.

16. The vibrating livestock prod of claim 1 wherein said trigger is selectively actable to permit pressurized or compressed gas to flow between said trigger and said scribe.

17. The vibrating livestock prod of claim 1 wherein said trigger is selectively actable to permit pressurized or compressed gas to flow from said trigger to said scribe.

18. The vibrating livestock prod of claim 1 wherein said trigger is selectively actable to permit pressurized or compressed gas to flow from said trigger to said scribe in order to vibrate said stylus.

19. The vibrating livestock prod of claim 1 wherein said trigger is selectively actable to permit pressurized or compressed gas to flow from said trigger to said scribe in order to vibrate said stylus against the skin of said animal.

20. The vibrating livestock prod of claim 19 wherein said gas is air or CO₂.

21. The vibrating livestock prod of claim 1 wherein said trigger is selectively actable to provide a pneumatic passageway.

22. The vibrating livestock prod of claim 1 wherein said trigger is selectively actable to provide a pneumatic passageway for pressurized or compressed gas to flow.

23. The vibrating livestock prod of claim 1 wherein said trigger is selectively actable to provide a pneumatic passageway for pressurized or compressed gas to flow between said trigger and said scribe.

24. The vibrating livestock prod of claim 1 wherein said trigger is selectively actable to provide a pneumatic passageway for pressurized or compressed gas to flow from said trigger to said scribe.

25. The vibrating livestock prod of claim 1 wherein said trigger is selectively actable to provide a pneumatic passageway for pressurized or compressed gas to flow from said trigger to said scribe in order to vibrate said stylus.

26. The vibrating livestock prod of claim 1 wherein said trigger is selectively actable to provide a pneumatic passageway for pressurized or compressed gas to flow from said trigger to said scribe in order to vibrate said stylus against the skin of said animal.

27. The vibrating livestock prod of claim 26 wherein said gas is air or CO₂.

28. A vibrating livestock prod with pneumatic actuation, comprising:
a pneumatic scribe having a vibratory stylus adapted for contacting a skin of an animal;
a pneumatic trigger; and
means for connecting said trigger to said scribe.

29. A vibrating livestock prod with pneumatic actuation, comprising:
a pneumatic scribe having a vibratory stylus adapted for contacting a skin of an animal, and
a pneumatic trigger in pneumatic communication with said scribe.

30. A vibrating livestock prod with pneumatic actuation, comprising:
a pneumatic scribe having a vibratory stylus adapted for contacting a skin of an animal, and
pneumatic means for vibrating said stylus.

31. A vibrating livestock prod with pneumatic actuation, comprising a pneumatic scribe having a vibratory stylus adapted for contacting a skin of an animal.

32. A vibrating livestock prod with pneumatic actuation, comprising pneumatic means for vibrating a stylus against a skin of an animal.

33. A system for motivating animal movement, comprising:
a) a vibrating livestock prod with pneumatic actuation, said prod comprising:
i) a pneumatic scribe having a vibratory stylus adapted for contacting a skin of an animal;
ii) a pneumatic trigger; and
iii) an elongated shaft connecting said trigger to said scribe; and
b) a pneumatic source connected to said prod.

34. The system of claim 33 wherein said source provides pressurized or compressed gas.

35. The system of claim 33 wherein said source provides pressurized or compressed gas to said prod.

36. The system of claim 33 wherein said source provides pressurized or compressed gas to said prod in order to vibrate said stylus.

37. The system of claim 33 wherein said source provides pressurized or compressed gas to said prod in order to vibrate said stylus against the skin of said animal.

38. The system of claim 37 wherein said gas is air or CO₂.

39. The system of claim 33 further comprising a pneumatic hose connecting said prod to said source.

40. The system of claim 33 wherein said source is remote from said prod.

41. The system of claim 33 wherein said source comprises a compressor.

42. The system of claim 33 wherein said source comprises a compressor from a slaughterhouse.

43. The system of claim 33 wherein said source is transportable.

44. The system of claim 33 wherein said source comprises one or more wheels for transport.

45. The system of claim 33 wherein said scribe is proximate a first distal end of said shaft and said trigger is proximate a second distal end of said shaft.

46. The system of claim 33 wherein said stylus is pneumatically acuated.

47. The system of claim 33 wherein said shaft is substantially hollow.

48. The system of claim 33 wherein said shaft contains a pneumatic passageway.

49. The system of claim 33 wherein said shaft provides a pneumatic passageway.

50. The system of claim 33 wherein said shaft supports a pneumatic passageway.

51. The system of claim 33 wherein said shaft permits pressurized or compressed gas to flow.

52. The system of claim 33 wherein said shaft permits pressurized or compressed gas to flow between said trigger and said scribe.

53. The system of claim 33 wherein said shaft permits pressurized or compressed gas to flow from said trigger to said scribe.

54. The system of claim 33 wherein said shaft permits pressurized or compressed gas to flow from said trigger to said scribe in order to vibrate said stylus.

55. The system of claim 33 wherein said shaft permits pressurized or compressed gas to flow from said trigger to said scribe in order to vibrate said stylus against the skin of said animal.

56. The system of claim 55 wherein said gas is air or CO₂.

57. The system of claim 33 wherein said trigger is selectively actable.

58. The system of claim 33 wherein said trigger is selectively actable to permit pressurized or compressed gas to flow.

59. The system of claim 33 wherein said trigger is selectively actable to permit pressurized or compressed gas to flow between said trigger and said scribe.

60. The system of claim 33 wherein said trigger is selectively actable to permit pressurized or compressed gas to flow from said trigger to said scribe.

61. The system of claim 33 wherein said trigger is selectively actable to permit pressurized or compressed gas to flow from said trigger to said scribe in order to vibrate said stylus.

62. The system of claim 33 wherein said trigger is selectively actable to permit pressurized or compressed gas to flow from said trigger to said scribe in order to vibrate said stylus against the skin of said animal.

63. The system of claim 62 wherein said gas is air or CO₂.

64. The system of claim 33 wherein said trigger is selectively actable to provide a pneumatic passageway.

65. The system of claim 33 wherein said trigger is selectively actable to provide a pneumatic passageway for pressurized or compressed gas to flow.

66. The system of claim 33 wherein said trigger is selectively actable to provide a pneumatic passageway for pressurized or compressed gas to flow between said trigger and said scribe.

67. The system of claim 33 wherein said trigger is selectively actable to provide a pneumatic passageway for pressurized or compressed gas to flow from said trigger to said scribe.

68. The system of claim 33 wherein said trigger is selectively actable to provide a pneumatic passageway for pressurized or compressed gas to flow from said trigger to said scribe in order to vibrate said stylus.

69. The system of claim 33 wherein said trigger is selectively actable to provide a pneumatic passageway for pressurized or compressed gas to flow from said trigger to said scribe in order to vibrate said stylus against the skin of said animal.

70. The system of claim 69 wherein said gas is air or CO₂.

71. A system for motivating animal movement, comprising:
a) a vibrating livestock prod with pneumatic actuation, said prod comprising:
i) a pneumatic scribe having a vibratory stylus adapted for contacting a skin of an animal;
ii) a pneumatic trigger; and
iii) means for connecting said trigger to said scribe; and
b) a pneumatic source connected to said prod.

72. A system for motivating animal movement, comprising:
a) a vibrating livestock prod with pneumatic actuation, said prod comprising:
i) a pneumatic scribe having a vibratory stylus adapted for contacting a skin of an animal, and
ii) a pneumatic trigger in pneumatic communication with said scribe; and
b) a pneumatic source connected to said prod.

73. A system for motivating animal movement, comprising:
a) a vibrating livestock prod with pneumatic actuation, said prod comprising:
i) a pneumatic scribe having a vibratory stylus adapted for contacting a skin of an animal;
ii) pneumatic means for vibrating said stylus; and
b) a pneumatic source connected to said prod.

74. A system for motivating animal movement, comprising:
a) a vibrating livestock prod with pneumatic actuation, said prod comprising a pneumatic scribe having a vibratory stylus adapted for contacting a skin of an animal; and
b) a pneumatic source connected to said prod.

75. A system for motivating animal movement, comprising:
a) a vibrating livestock prod with pneumatic actuation, said prod comprising pneumatic means for vibrating a stylus against a skin of an animal; and
b) a pneumatic source connected to said prod

76-124. (canceled)
